(19) United States
(12) Patent Application Publication
(10) Pub. No.: US 2010/0176206 A1
(43) Pub. Date: Jul. 15, 2010

(54) Memory Card

(75) Inventors: Jae-hwan Han, Seoul (KR); Tae-bo Kim, Gyeonggi-do (KR); Kyung-woo Ko, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/632,962

(22) Filed: Dec. 8, 2009

(30) Foreign Application Priority Data
Jan. 13, 2009 (KR) 10-2009-0002717

(51) Int. Cl. G06K 19/07

(52) U.S. Cl. 235/492

(57) ABSTRACT

Provided is a memory card that reinforces rigidity of a product, and increases the value of the product by improving the appearance of the product. The memory card includes a semiconductor chip; a case installed to surround the semiconductor chip; and a reinforcement member attached to one surface of the case so that rigidity of the case is increased. The surface of the case can be textured or marked by a variety of surface finishing techniques.

### CROSS-REFERENCE TO RELATED APPLICATIONS

This application claims the benefit of Korean Patent Application No. 10-2009-0002717, filed on Jan. 13, 2009, in the Korean Intellectual Property Office, the disclosure of which is incorporated herein in its entirety by reference.

### BACKGROUND

The inventive concept relates to a memory card, and more particularly, to a memory card that has increased rigidity of the card by using a reinforcement member formed of a metal material, and increases the value of the product by improving the appearance of the product.

As use of mobile devices, such as digital cameras, digital camcorders, MP3 players, personal digital assistant (PDA), digital audio players, etc. increases, mobile storage devices, such as flash memory devices or magneto-optical micro drives, are more widely used.

Mobile storage devices need high capacity memory owing to the improvement of performance of and the increased applications for mobile digital devices. This results in an increased demand for high capacity mobile storage devices.

Flash memory devices include a variety of types of compact flash devices, smart media devices, multimedia cards, secure digital (SD) memory cards, memory stick cards, etc. In particular, SD memory cards are widely used owing to their excellent perfoimance including data transmission.

Although semiconductor chips embedded in SD memory cards are protected by a case formed of a plastic material, the case formed of the plastic material is susceptible to bending and twisting forces, shocks, scratches, etc.

### SUMMARY

The inventive concept provides a memory card that includes a reinforcement member or a case which is formed of a metal material with increased bending rigidity and/or twisting rigidity and that reinforces overall rigidity of the case, thereby better protecting a semiconductor chip embedded in the memory card. Appearance of the product is improved and made more aesthetic by using the characteristics of the metal to achieve various surface finishes. This use of the metal and its characteristics make an improved product by protecting the product from scratches, and providing an opportunity to use various designs of printing, marking, and color.

According to an aspect of the inventive concept, there is provided a memory card including: a semiconductor chip; a case installed to surround the semiconductor chip; and a reinforcement member attached to at least one surface of the case so that rigidity of the case is reinforced.

The memory card may be a secure digital (SD) card.

The case may include: an upper case surrounding the upper surface of a package including the semiconductor chip; and a lower case surrounding the lower surface of the package, wherein a reinforcement member is installed on the exterior surface of the upper case and/or on the exterior surface of the lower case.

The reinforcement member may be a metal plate.

The metal plate may have a textured surface through surface processing or surface treatments.

A coating film may be formed on the surface of the reinforcement member.

A marking region for indicating product information may be formed on the exterior surface of the reinforcement member.

A bonding, layer may be formed between the reinforcement member and the case.

The case may be formed of a metal material.

According to another aspect of the inventive concept, there is provided a memory card including: a semiconductor chip; and a metal case installed to surround the semiconductor chip.

### BRIEF DESCRIPTION OF THE DRAWINGS

Exemplary embodiments of the inventive concept will be more clearly understood from the following detailed description, taken in conjunction with the accompanying drawings in which:

FIG. 1 is an exploded perspective view of a memory card as an exemplary embodiment;

FIG. 2 is a perspective view of a memory card shown in FIG. 1 as an exemplary embodiment;

FIG. 3 is a cross-sectional view of the memory card shown in FIG. 2 as an exemplary embodiment;

FIG. 4 is a cross-sectional view of a reinforcement member (e.g., a metal plate) shown in FIG. 3 as an exemplary embodiment;

FIG. 5 is a cross-sectional view of the reinforcement member (the metal plate) shown in FIG. 4 as another exemplary embodiment;

FIG. 6 is a cross-sectional view of the reinforcement member (the metal plate) shown in FIG. 4 as another exemplary embodiment; and

FIG. 7 is an exploded perspective view of a memory card as another exemplary embodiment.

### DETAILED DESCRIPTION OF THE EMBODIMENTS

The invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. As used herein the term “and/or” includes any and all combinations of one or more of the associated listed items.

The terminology used herein is for the purpose of describing particular embodiments only and is not intended to be limiting of the invention. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being, “connected” “attached” or “coupled” to another element, it can be directly connected, attached or coupled to the other element or intervening elements may be present. In contrast, when an element is referred to as being “directly connected”, “directly attached” or “directly coupled” to another element, there are no intervening, elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

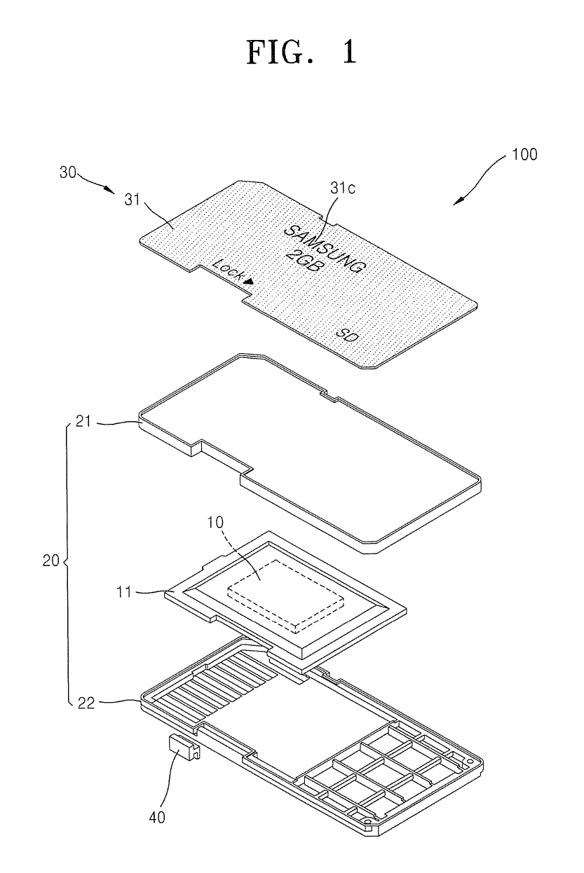

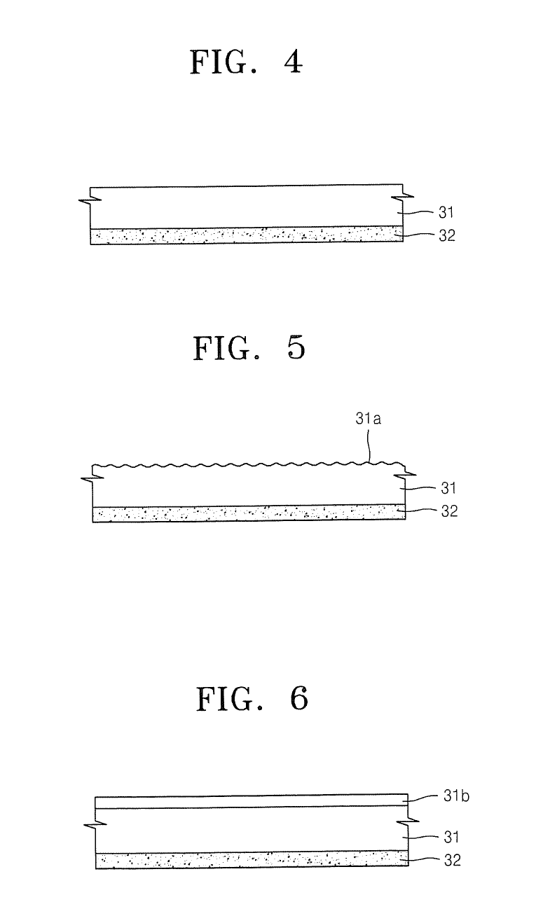

A Secure Digital (SD) form-factor compliant memory card (or memory card) 100 according to some embodiments of the invention is shown. As used herein, the term “form-factor” means the physical size and shape of the memory card. Moreover, the form-factor of memory cards according to some embodiments of the invention is described herein as a Secure Digital memory card that has a size and shape that allows such memory cards to be used with other compliant devices, such as readers. As known to those skilled in the art, SD represents a later developed version of the Multimedia Memory Card (MMC) standard which may allow MMC compliant memory cards to be used with SD compliant devices. In some embodiments according to the invention, SD foim-factor compliant devices measure about 32 mm×about 24 mm×about 1.4 mm and can be shaped substantially as shown in FIGS. 1 and 4. The MMC and SD standards are discussed further on the world-wide-web at “www.mmca.org.” Other form-factor memory cards may also be practiced according to the present invention.

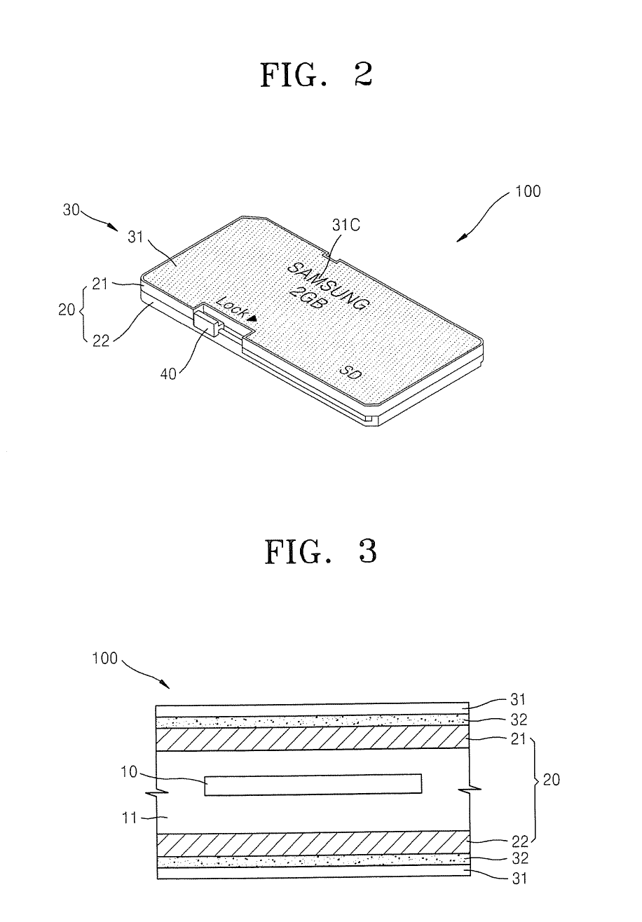

FIG. 1 is an exploded perspective view of a memory card 100 as an exemplary embodiment. FIG. 2 is a perspective view of the memory card 100 shown in FIG. 1 as an exemplary embodiment. FIG. 3 is a cross-sectional view of the memory card 100 shown in FIG. 2 as an exemplary embodiment. FIG. 4 is a cross-sectional view of a reinforcement member 30 (a metal plate 31) shown in FIG. 3 as an exemplary embodiment.

Referring to FIGS. 1 through 4, the memory card 100 of the exemplary embodiment includes a semiconductor chip 10, a case 20, and the reinforcement member 30.

The semiconductor chip 10 as a package 11 molded by a sealing material may be assembled with the case 20 as shown in FIG. 1.

The case 20 is assembled with the package 11 to surround or envelop the package 11 including the semiconductor chip 10. The case 20 may include an upper case 21 that surrounds or envelops the upper surface of the package 11 including the semiconductor chip 10 and a lower case 22 that surrounds or envelops the lower surface of the package 11.

The case 20 may be formed of a plastic material. A write-hold tab 40 may be installed at one side of the case 20 as shown in FIGS. 1 and 2.

The case 20 may be formed of a metal material having a strong increased durability, in addition to or as an alternative to the plastic material.

The memory card 100 may be of a variety of types of memory cards, such as a compact flash memory card, a smart media memory card, a multimedia card, a memory stick, etc. The memory card 100 may be a secure digital (SD) memory card.

The reinforcement 30 is attached to one side or both sides of the case 20 so that rigidity of the case 20 can be increased. The reinforcement member 31 may be attached to an outer surface of the upper case 21 and an outer surface of the lower case 22 as shown in FIG. 3.

In particular, the reinforcement 30 may be the reinforcement member 31 in the form of a metal plate, which improves bending rigidity and twisting rigidity, reduces various shocks, and resists scratches. The metal plate 31 is suitable for various surface finish treatments as well as printing or marking.

The metal plate 31 may be formed of a stainless steel alloy, an aluminum alloy, a nickel alloy, a chrome alloy, a tin alloy, a copper alloy, a zinc alloy, etc., which are strong in corrosion, are lightweight, and are highly rigid.

The metal plate 31 may have a smooth surface, like the surface of a mirror as shown in FIG. 4. The metal plate 31 may have a irregular surface 31a through surface processing or treatment, such as the process of carving a detailed or “hair line” line or a sand blasting process using sand, and/or carbon steel particles as shown in FIG. 5.

The surface processing, such as hair-line processing or sanding processing, realizes a coarse mat metal surface, making a product different and distinguishable from other or non-surface processed assemblies.

Referring to FIG. 6, a coating film 31b may be formed on the surface of the metal plate 31 through spraying, dipping, deposition, painting, diffusing, and/or plating.

The coating film 31b may be used to realize various colors, facilitate marking, provide insulation, or prevent a scratch, thereby easily realizing various functions and designs.

Meanwhile, referring to FIGS. 1 and 2, a marking region 31c indicating product information may be formed on the exterior surface of the metal plate 31.

The marking in region 31c may be formed through various processes such as printing, laser marking, etching, pressing, punching, etc.

Referring to FIGS. 3 through 6, a bonding layer 32 may be formed between the reinforcement member 31 and the case 20.

The bonding layer 32 may be formed by an adhesive, such as a tape with adhesive on both sides, a thermal welding tape, or an epoxy resin, and may be used to easily bond the reinforcement member 31 to the upper case 21 and the lower case 22.

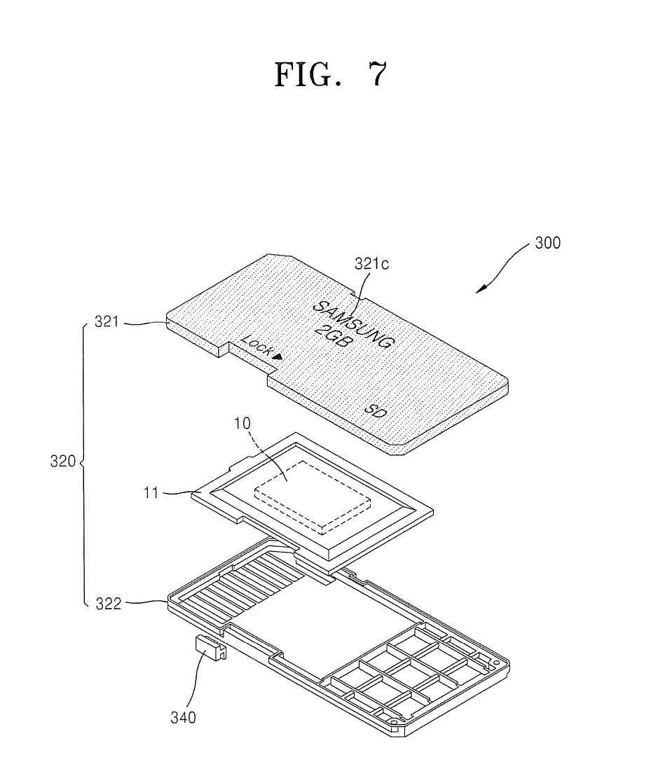

FIG. 7 is an exploded perspective view of a memory card 300 according to another exemplary embodiment. Referring to FIG. 7, the memory card 300 of the exemplary embodiment includes a package 11 including a semiconductor chip 10 and a case 320 that is formed of a metal material and surrounds the package 11 including the semiconductor chip 10.

The case 320 formed of the metal material is assembled to surround the package 11 including the semiconductor chip 10. The case 320 may include an upper case 321 that surrounds or envelops the upper surface of the package 11 including the semiconductor chip 10 and a lower case 322 that surrounds or envelops the lower surface of the package 11. A write-hold tab 340 may be installed at one side of the case 320.

Therefore, the memory cards 100 and 300 of the inventive concept increase resistance to shock, bending rigidity, twisting rigidity, scratch resistance, etc. by using the reinforcement member 31 formed of metal material or the case 320 formed of metal material, increase a customer's interest by making an improved product that is distinguishable from other memory cards, and providing various designs by printing, surface finishing, marking, and color.

The memory card of the inventive concept increases rigidity of a case, thereby protecting a semiconductor chip embedded in the memory card and making an improved product capable of being distinguished, protecting the product from scratches, and providing various designs of printing, marking, and color.

While the inventive concept has been particularly shown and described with reference to exemplary embodiments thereof, it will be understood that various changes in form and details may be made therein without departing from the spirit and scope of the following claims.

What is claimed is:

1. A memory card comprising:
a semiconductor chip;
a case installed to surround the semiconductor chip; and
a reinforcement member attached to the surface of the case so that rigidity of the case is increased.

2. The memory card of claim 1, wherein the memory card is a secure digital (SD) card.

3. The memory card of claim 1, wherein the case comprises: an upper case surrounding the upper surface of a package including the semiconductor chip; and a lower case surrounding the lower surface of the package,
wherein the reinforcement member is installed on the exterior surface of the upper case or on the exterior surface of the lower case.

4. The memory card of claim 1, wherein the reinforcement member is a metal plate.

5. The memory card of claim 4, wherein the metal plate has a textured surface through surface processing.

6. The memory card of claim 1, wherein a film is formed on the surface of the reinforcement member.

7. The memory card of claim 1, wherein a marking region indicating product information is formed on the exterior surface of the reinforcement member.

8. The memory card of claim 1, wherein a bonding layer is formed between the reinforcement member and the case.

9. The memory card of claim 1, wherein the case is formed of a metal material.

10. A memory card comprising:
a semiconductor chip; and
a metal case installed to surround the semiconductor chip.

11. The memory card of claim 10, wherein the semiconductor chip is contained within a package.

12. The memory card of claim 11, wherein the metal case comprises:
an upper case enveloping an upper surface of the package;
a lower case enveloping a lower surface of the package;
a bonding layer formed on an exterior surface of the case; and
a reinforcement member attached to the case by the bonding layer.

13. The memory card of claim 12 further comprising a surface finish on the case for indicating a functional characteristic of the memory card.

14. The memory card of claim 12 further comprising a surface finish on the case for indicating, the origin of said memory card.

15. A secure digital (SD) memory card comprising:
a semiconductor chip;
a package surrounding the semiconductor chip;
a metal case surrounding the package;
a bonding layer on the surface of the case; and
a metal reinforcement member attached to the surface of the case by the bonding layer
